(19) United States
(12) Patent Application Publication
(10) Pub. No.: US 2009/0282199 A1
(43) Pub. Date: Nov. 12, 2009

(54) Memory control system and method

(76) Inventors: Michael B. Cox, Nenlo Park, CA (US); John B. Newlin, Belmont, CA (US); Marc R. Delvaux, Atherton, CA (US); Laura R. Carns, San Jose, CA (US); Mohamed A. (Dali) Kilani, Palo alto, CA (US)

Correspondence Address: NVIDIA C/O MURABITO, HAO & BARNES LLP, TWO NORTH MARKET STREET, THIRD FLOOR, SAN JOSE, CA, 95113, US

(21) Appl. No.: 12/002,565

(22) Filed: Dec. 17, 2007

Related U.S. Application Data
(60) Provisional application No. 60/964,956, filed on Aug. 15, 2007.

(51) Int. Cl. G06F 12/02

(52) U.S. Cl. 711/154; 711/E12.002

(57) ABSTRACT

The present invention systems and methods enable dynamic allocation and control of on-chip memory. In one embodiment, a system includes a plurality of internal memory components and a control component. The plurality of internal memory components store information. The control component controls access requests from a plurality of heterogeneous components to the internal memory components. The plurality of internal memory components are dynamically assigned to the plurality of heterogeneous components. The heterogeneous components can include different types of engines. In one embodiment, the system includes a clock compensation component for coordinating clocking for access requests from the heterogeneous engines.

### RELATED APPLICATIONS

This Application is related to and claims the benefit and priority of co-pending provisional Application Ser. No. 60/964,956 (Attorney Docket NVID-P003627.PRO) entitled “A MEMORY CONTROL SYSTEM AND METHOD” filed Aug. 15, 2007.

### FIELD OF THE INVENTION

The present invention relates to the field of memory control.

### BACKGROUND OF THE INVENTION

Electronic systems and circuits have made a significant contribution towards the advancement of modern society and are utilized in a number of applications to achieve advantageous results. Numerous electronic technologies such as digital computers, calculators, audio devices, video equipment, and telephone systems have facilitated increased productivity and reduced costs in analyzing and communicating data in most areas of business, science, education and entertainment. Electronic systems providing these advantageous results often include different types of memory.

There are a number of implementations in which internal memory and/or level 2 cache memory is utilized. On-chip memory is typically an expensive and limited resource. It generally provides significantly higher performance than external memory by providing higher bandwidth with lower latency to the processors that have access to it. Some chips provide a relatively large single “big buffer” that software can allocate for use by a single dedicated homogeneous engine. Some chips provide level 2 cache memory that can be used by a homogeneous Central Processing Unit (CPU) or by several homogeneous CPUs.

### SUMMARY

The present invention systems and methods enable dynamic allocation and control of on-chip memory. In one embodiment, a system includes a plurality of internal memory components and a control component. The plurality of internal memory components store information. The control component controls access requests from a plurality of heterogeneous components to the internal memory components. The plurality of internal memory components are dynamically assigned to the plurality of heterogeneous components. The heterogeneous components can include different types of engines. In one embodiment, the system includes a clock compensation component for coordinating clocking for access requests from the heterogeneous engines.

### DESCRIPTION OF THE DRAWINGS

The accompanying drawings, which are incorporated in and form a part of this specification, illustrate embodiments of the invention by way of example and not by way of limitation. The drawings referred to in this specification should be understood as not being drawn to scale except if specifically noted.

FIG. 1 is a block diagram of an exemplary processing system in accordance with one embodiment of the present invention.

FIG. 2 is a block diagram of an exemplary memory controller in accordance with one embodiment of the present invention.

FIG. 3 is a block diagram of exemplary memory control method 300 in accordance with one embodiment of the present invention.

### DETAILED DESCRIPTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well known methods, procedures, components, and circuits have not been described in detail as not to unnecessarily obscure aspects of the present invention.

Some portions of the detailed descriptions which follow are presented in terms of procedures, logic blocks, processing, and other symbolic representations of operations on data bits within a computer memory. These descriptions and representations are the means generally used by those skilled in data processing arts to effectively convey the substance of their work to others skilled in the art. A procedure, logic block, process, etc., is here, and generally, conceived to be a self-consistent sequence of steps or instructions leading to a desired result. The steps include physical manipulations of physical quantities. Usually, though not necessarily, these quantities take the form of electrical, magnetic, optical, or quantum signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are associated with the appropriate physical quantities and are merely convenient labels applied to these quantities. Unless specifically stated otherwise as apparent from the following discussions, it is appreciated that throughout the present application, discussions utilizing terms such as “processing”, “computing”, “calculating”, “determining”, “displaying” or the like, refer to the action and processes of a computer system, or similar processing device (e.g., an electrical, optical, or quantum, computing device), that manipulates and transforms data represented as physical (e.g., electronic) quantities. The terms refer to actions and processes of the processing devices that manipulate or transform physical quantities within a computer system's component (e.g., registers, memories, other such information storage, transmission or display devices, etc.) into other data similarly represented as physical quantities within other components.

Present invention memory control systems and methods facilitate utilization of on chip data store resources for both dedicated device storage and heterogeneous device storage. In one embodiment, on-chip internal memory is programmable for dynamic allocation as dedicated processor cache or on-chip memory buffers available for utilization by a variety of heterogeneous components. The dynamic allocation can be implemented in accordance with application or usage case. In one exemplary implementation, the allocation is performed in a manner that maintains access latency and bandwidth as if the memory resources were dedicated on-chip memory. The allocation can also be configured to facilitate avoidance of conflicts between heterogeneous engine accesses.

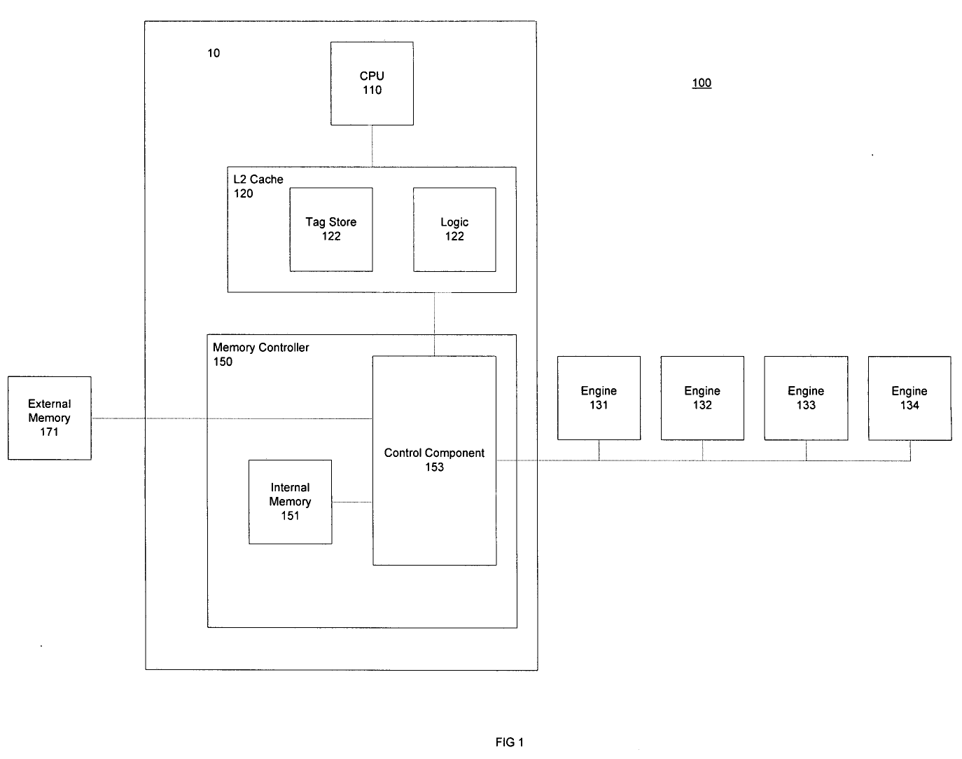

FIG. 1 is a block diagram of an exemplary processing system 100 in accordance with one embodiment of the present invention. Processing system 100 includes central processing component 110, level 2 cache 120, memory controller 150, and engines 131, 132, 133 and 134 and external memory 171. Central processing component 110, level 2 cache 120, and memory controller 150 are internal components on chip 10 and engines 131, 132, 133 and 134 and external memory 171 are external components off chip 10. It is appreciated in another exemplary implementation that one or more of the engines 131, 132, 133 and 134 can be included on chip. Memory controller 150 is coupled to engines 131, 132, 133 and 134, external memory 171, and level 2 cache 120 which in turn is coupled to central processing component 110. Level 2 cache 120 includes logic and tag store for coordinating CPU level 2 cache memory access. Memory controller 150 includes internal memory 151 and control component 153.

The components of exemplary processing system 100 cooperatively operate to dynamically allocate internal memory (e.g., internal memory 151) storage space to a plurality of heterogeneous components. The plurality of heterogeneous components perform a variety of operations. In one embodiment, the heterogeneous components include central processing component 110, and engines 131 through 134. The heterogeneous components can perform a variety of processing and other operations. The heterogeneous components can include a variety of different types of engines, a disparate collection of general purpose processing units, dedicated processing units, dedicated hardware engines, graphics processing engine, and audio/video engines. It is appreciated the graphics processing engine can include a graphics processing unit (GPU).

Memory controller 150 controls dynamic allocation or assignment of the memory to the plurality of heterogeneous engines, including dynamic allocation of the internal memory 151 to the plurality of heterogeneous engines. The memory controller 150 avoids or prevents conflicts in memory accesses granted to the plurality of internal memory components by ensuring a device does not access a memory component or section allocated to a different device. The memory controller 150 also controls access requests from the plurality of heterogeneous components to the internal memory and external memory. The memory controller 150 can also direct clock compensation for differences in clock rates of the plurality of heterogeneous engines. In one exemplary implementation, the memory controller 150 directs dynamic selection between a plurality of clock rates for utilization as an internal memory clock rate, wherein the plurality of clock rates include a first clock rate that corresponds to a cache and a second clock rate that corresponds to a master control clock rate. For example, the memory controller 150 selects the first clock rate corresponding to the cache clock rate when the internal memory is allocated to the cache and the memory controller selects the second clock rate corresponding to a master clock rate when the internal memory is allocated to a heterogeneous engine.

In one embodiment, the memory controller includes a plurality of internal memory components. The memory controller can allocate the internal memory based on boundaries of the internal memory components. In one exemplary implementation, the internal memory components include blocks of static random access memory (SRAM) and the memory control component allocates memory based on the boundaries of the blocks of SRAM. In one embodiment, the dynamic assignment is performed in accordance with performance indications.

The control component 153 controls access to memory (e.g., internal memory 151, external memory 171, etc.). In one embodiment, memory control component 150 processes requests from the plurality of heterogeneous components in accordance with the allocation boundaries between the plurality of internal memory components. The control component 153 can also control access to external memory components (e.g., external memory 171) by the plurality of heterogeneous components. It is appreciated that a present invention memory control system and method can be implemented in a variety of configurations.

In one embodiment, a memory control component includes an access routing mechanism. The access routing mechanism can include an arbiter for arbitrating access requests to the plurality of internal memory components while allowing multiple clients access to an allocated internal memory component. The access routing mechanism can include a tri-state bus for selecting client to memory paths to the plurality of internal memory components in accordance with allocation, while avoiding extra cycles on a client to memory access path. The access routing mechanism can include a multiplexer for selecting client to memory paths for the plurality of internal memory components in accordance with the memory allocation, while avoiding extra cycles on a client to memory access path.

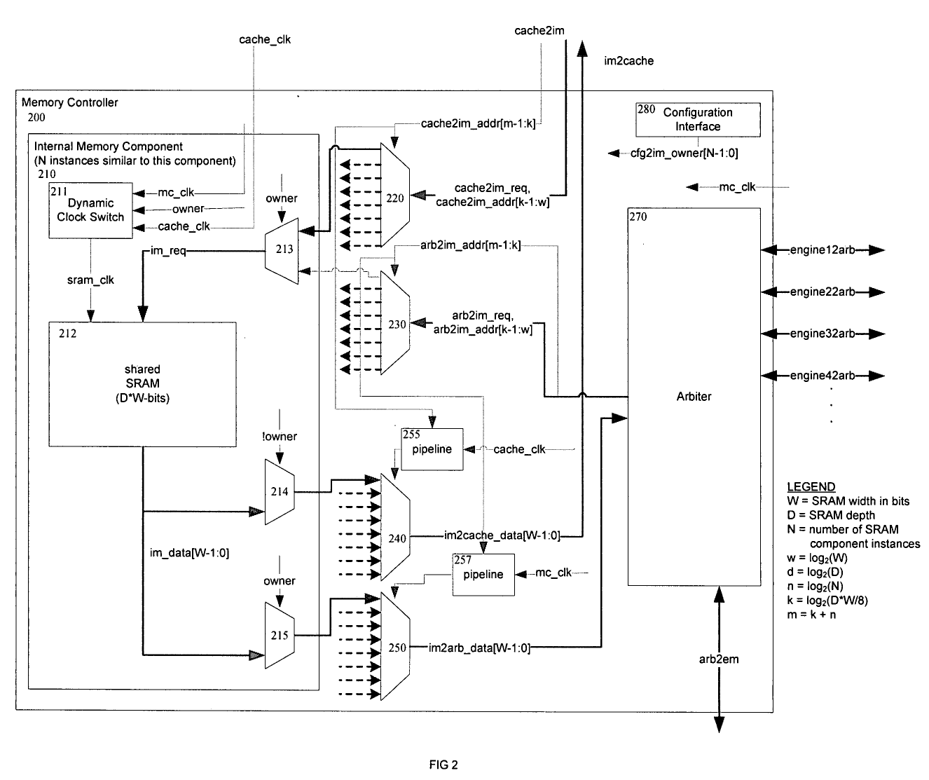

FIG. 2 is a block diagram of memory controller 200 in accordance with one embodiment of the present invention. In one embodiment, on chip internal memory is allocated to client caches or client buffers. In one exemplary implementation, on chip internal memory can be allocated to a CPU cache or to buffers for other engines, (e.g., a GPU, other media engines, etc.) The allocation can be based on usage-case, benchmark, or application. More memory can be allocated to the CPU L2 cache when general-purpose software is a bottleneck due to working set size and/or latency, or alternatively more memory can be allocated to the dedicated buffers when the performance bottleneck is due to dedicated engine memory performance. In one embodiment, memory controller 200 is similar to memory controller 150.

Memory controller 200 includes internal memory component 210, routing components 220, 230, 240 and 250, pipeline 255, pipeline 257 arbiter 270 and configuration interface component 280. It is appreciated that memory controller 200 can have a plurality of internal memory components similar to internal memory component 210 (others not shown to avoid obscuring the invention). In one embodiment memory controller 200 includes N instances of internal memory components similar to internal memory component 210. Internal memory component 210 is coupled to selection components 220, 230, 240 and 250, which in turn are coupled to arbiter 270. Configuration interface component 280 is also coupled to internal memory component 210 via owner signals. Pipeline components 255 and 257 are coupled to routing component 240 and 250 respectively.

The components of memory controller 200 cooperatively operate to allocate internal memory storage resources. Internal memory component 210 stores information. Selection components 220 through 250 select and route information to and from the plurality of internal memory components including internal memory component 210. Arbiter 270 arbitrates access between the external heterogeneous engines to and from either internal memory component 210 and an external memory component (not shown). Pipelines 255 and 257 control access return information in accordance with internal memory addresses from a cache and arbiter. Configuration interface 280 coordinates accesses to prevent conflicts between a cache access and an external engine access.

In one embodiment, arbiter 270 receives requests from heterogeneous engines via memory access request or read signals (e.g., engine 12 arb signal, engine 12 arb signal, engine 32 arb signal, engine 42 arb signal, etc.). The arbiter 270 forwards request information from the heterogeneous engines to an internal memory component (e.g., internal memory component 210) via selection component 230 if the internal memory component is allocated for utilization by the external engines. For example, arbiter 270 forwards the request information via an arbiter to internal memory request bus (arb2im_req) and arbiter to internal memory address bus (arb2im_addr[k−1:w]). In one exemplary implementation, [k−1:w] is defined as log₂(D*W/8) in which W is the width of the internal memory storage component in bits, w is log₂(W), and D is the depth in words. The arbiter 270 forwards request information from the heterogeneous engines to an external memory component (not shown) via an arbiter 2 external memory signal (e.g., arb2em) if the external memory component is allocated for utilization by the external engines.

In one embodiment, the corresponding selection components 220 through 250 select and route access requests and returns to and from the plurality of internal memory components including internal memory component 210. Selection component 220 receives cache to internal memory request (e.g., via cahce2im_req) and cache to internal memory address (e.g., via cache2im_address[k−1:w]). In one exemplary implementation, [k−1:w] is defined as log₂(D*W/8) in which W is the width of the internal memory storage component in bits, w is log₂(W), and D is the depth in words. Selection component selects an output for forwarding the request to an internal memory component based upon the addresses assigned to the corresponding internal memory component. The address selection can correspond to a cache to internal memory address signal cache2_im[m−1:k]wherein m defined as m=k+n and k is log₂(D*W/8) and n is log₂(N) where N is the number of memory component instances in the plurality of memory components.

Selection component 230 receives arbiter to internal memory request (e.g., via c2im_req) and arbiter to internal memory address (e.g., via arbiter 2im_address[k−1:w]). In one exemplary implementation, [k−1:w] is defined as log₂(D*W/8) in which W is the width of the internal memory storage component in bits, w is log₂(W) and D is the depth in words. Selection component selects an output for forwarding the request to an internal memory component based upon the addresses assigned to the corresponding internal memory component. The address selection can correspond to by an arbiter to internal memory address signal arb2_im[m−1:k] wherein m defined as m=k+n and k is log₂(D*W/8) and n is log₂(N) where N is the number of memory component instances in the plurality of memory components.

Selection component 240 receives internal memory return data (e.g., via im_data[W−1:0]) and forwards the selected information to the cache. In one exemplary implementation, the information is forwarded via an internal memory to cache data bus (e.g., im2cache_data [W−1:0]). Selection component 240 selects return data for forwarding based upon direction from pipeline component 255. Pipeline component 255 coordinates the return selection based upon a corresponding request information from the cache (e.g., cache_{—}2im_addr[m−1:k]) and pipeline delay associated with retrieving the information from the shared memory 212. In one embodiment, pipeline component 255 is controlled by a cache clock signal cache_clk.

Selection component 250 receives internal memory return data (e.g., via im_data[W−1:0]) and forwards the selected information to the arbiter for distribution to the external engines. In one exemplary implementation, the information is forwarded via an internal memory to arbiter data bus (e.g., im2arb_data [W−1:0]). Selection component 250 selects return data for forwarding based upon direction from pipeline component 257. Pipeline component 257 coordinates the return selection based upon a corresponding request information from the arbiter (e.g., arb_{—}2im_addr[m−1:k]) and pipeline delay associated with retrieving the information from the shared memory 212. In one embodiment, pipeline component 257 is controlled by a master control clock signal (mc_clk).

In one embodiment, internal memory component 210 includes a shared internal memory component 212, contention regulators 213, 214, and 215 and a dynamic clock switch 211. In one exemplary implementation, internal memory component 212 includes Static Random Access Memory (SRAM) components for storing information. The SRAM can be configured to have a width of W bits and a depth of D words with a capacity of D*W bits. The internal memory component can be accessed by an internal memory request signal (e.g., via im_req bus ) and forwards return information in an internal memory data return signal (e.g., via im_data [W−1:0] bus). Dynamic clock switch 211 facilitate selection of a master control clock signal (mc-clk) or a cache clock signal (cache_clk). Contention regulators 213, 214, and 215 select an “owner” of the allocated stared memory 212 in accordance with direct direction from configuration interface 280.

In one embodiment, configuration interface 280 forwards ownership signals (e.g., cfg-2im_owner[N−1:0] to direct ownership or allocation of a shared memory to either a cache or arbiter 270, which in turn directs the memory allocation for utilization to an external homogenous engine. For example, ownership of shared memory 212 and other shared memory components in other internal memory component share memory instances or blocks (not shown) is allocated to either a cache or arbiter, wherein the arbiter can coordinate the allocation with respective engines. In one exemplary implementation, the owner signal shown coupled to contention regulator 213, contention regulator component 215 and dynamic clock switch 211 is one of the corresponding configuration to internal memory owner signals (e.g., cfg2im_owner[N−1:0]) and a corresponding not owner signal (e.g., !owner) is coupled to contention regulator 214. The configuration of the owner signals is coordinated to prevent contention in accesses to the same internal memory for cache utilization and external heterogeneous engine utilization. For example, the owner signal forwarded to contention regulator 213 which forwards either an access request from a cache or arbiter 270. Similarly, the owner signal forwarded to contention regulator 215 and not owner signal forwarded to contention regulator 214 ensure that the corresponding return data is forwarded to either the cache or arbiter 270 in accordance with which on requested the return data.

In one embodiment, the programmable allocation of an on-chip memory resources available for programmable allocation or on-chip memory pool is performed in a manner such that access time and bandwidth are as fast or high as the time for dedicated on chip memory. In one exemplary implementation, an L2 cache hit to memory allocated from the on chip memory resources available for programmable allocation is as fast as a cache hit to on-chip memory dedicated to L2 storage. The rate can be clock for clock. Clocking relationships between clients and allocated on-chip memory can be maintained. In one embodiment, a first client can access a dedicated on-chip memory and allocated memory synchronously.

In one embodiment, a memory control system includes a clock compensation component for coordinating clocking for access requests from the heterogeneous engines. For example, internal memory component 210 includes dynamic clock switch 211. In one exemplary implementation, dynamic clock switch 211 includes a clock signal section system. A clock signal selection system and method can facilitate selection of an active clock signal. In one exemplary implementation, dynamic clock switch 211 selects between master control clock (e.g., mc-clk signal) and cache clock (e.g., cache_clk) based upon selection input from owner signals and forwards the selected signal as a memory clock signal (e.g., sram_clk). The cache clock signal (e.g., cache_clk) can be forwarded to pipeline component 255 and master clock signal (mc_clk) can be forwarded to pipeline component 257 to coordinate timing of return data from shared memory 212.

In one embodiment, an active clock signal is selected from a plurality of incoming clock signals and the incoming clock signals are utilized in controlling the changing or selection of one of the plurality of clock signals as the active clock signal. For example, in dynamic clock switch 211 the incoming clock signals master clock mc_clk and cache_clk can be utilized in controlling the changing or selection of one or the other as the active clock signal (e.g., sram_clk). In one embodiment, a one-hot multiplexer interface is utilized. A cross coupled feedback technique can be utilized to ensure a first one of the plurality of incoming clock signals is deselected before a second one of the plurality of incoming clock signals is selected as the active clock signal. In one exemplary implementation, the plurality of incoming clock signals span different clock domains. Exemplary clock signal selection systems and methods are described in co-pending US patent application entitled Clock Selection System and Method, application Ser. No. 11/893,500, Attorney Client Docket Number NIVD-P002930, filed Aug. 15, 2007, and incorporated herein by this reference.

In one embodiment, a first portion or first region of on-chip memory is allocated for dedicated cache usage by a first client and a second client can not cause contention simply because the second client is accessing a different second portion or second region of the on-chip memory. In one embodiment, contention is prevented in the on-chip memory pool subsystem by memory bank ownership. In one embodiment, an on-chip or internal memory includes m banks of M Bytes each. When pool memory is allocated for a client cache in the system, it is allocated in granules of M Bytes. When pool memory is allocated for client buffers in the system, it is also allocated in M Bytes. In one exemplary implementation, there is no contention between a client accessing its data cache and different clients accessing their buffers and/or data caches. In one embodiment, a cache is an associative cache. In one exemplary implementation, a portion of the internal memory banks are allocated to cache and the remaining portion is allocated for use and internal memory accessible directly in an address map.

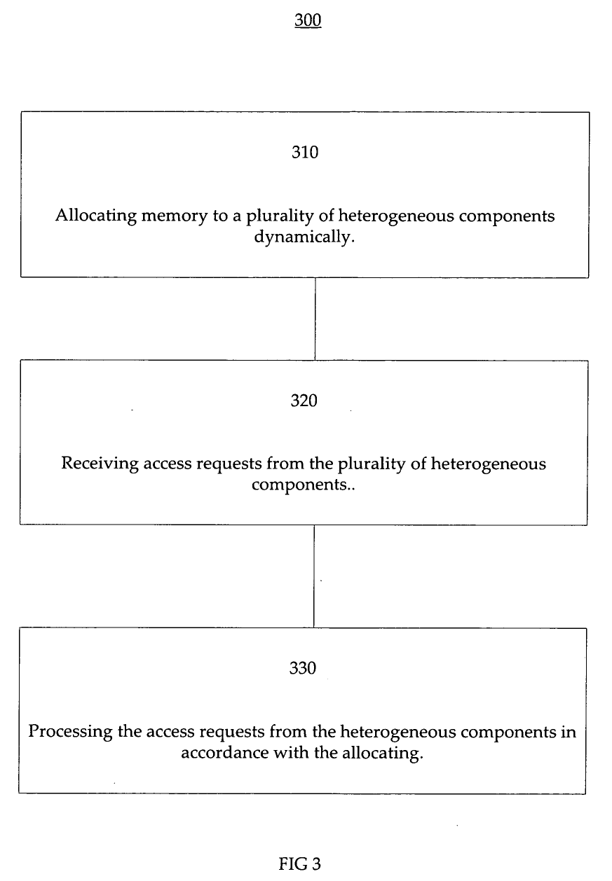

FIG. 3 is a block diagram of exemplary memory control method 300 in accordance with one embodiment of the present invention.

In block 310, internal memory is dynamically allocated. In one embodiment the internal memory is dynamically allocated to a plurality of heterogeneous components. The internal memory can also be dynamically allocated for dedicated usage. In one exemplary implementation, the internal memory can also be dynamically allocated to a cache. Allocation of the internal memory can be performed on a complete or whole allocation for heterogeneous component usage and none to dedicated component usage, vise versa, or a portion or part of the internal memory can be allocated for usage by the heterogeneous components and another portion or part can be allocated for dedicated usage by a particular component. In one embodiment, the internal memory is allocated between cache usage by a processor and buffer usage by other heterogeneous engines or components. The allocation can be performed dynamically in accordance with a performance indication. The performance indication can include a usage-case indication, a bench mark indication and or application indication. In one embodiment, the internal memory can be dynamically allocated for use by a dedicated component or heterogeneous components.

In block 320, access requests are received. In one embodiment, access requests are received from the plurality of heterogeneous components. The access requests can come from a particular component that has been allocated a portion of the internal memory for dedicated use by the particular component. In one embodiment, an access request from one of the plurality of heterogeneous engines is selected for forwarding to an internal memory component. In one exemplary implementation, arbitration between the plurality of heterogeneous component access requests is performed to select the request for forwarding.

In block 330, the access requests from the heterogeneous components are processed in accordance with the allocation. In one embodiment, the selected request is routed to the corresponding allocated portion of the memory. In one exemplary implementation, ownership for the allocated memory space is restricted or prevented in accordance with the allocation and access contention is prevented. The access requests can be processed with compensation for different clock rates of the heterogeneous components.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1. A memory control system comprising:
a plurality of internal memory components; and
a control component for controlling access requests from a plurality of heterogeneous components to said internal memory components.

2. A memory control system of claim 1 wherein said heterogeneous components include different types of engines.

3. A memory control system of claim 1 further comprising a clock compensation component for coordinating clocking for access requests from said heterogeneous engines.

4. A memory control system of claim 1 wherein said plurality of internal memory components are dynamically assigned to said plurality of heterogeneous components.

5. A memory control system of claim 4 wherein said assignment is performed in a manner that avoids conflicts.

6. A memory control system of claim 5 wherein said control component processes requests from said plurality of heterogeneous component in accordance with allocation boundaries between said plurality of internal memory components.

7. A memory control system of claim 4 wherein said dynamic assignment is performed in accordance with performance indications.

8. A memory control system of claim 1 wherein said control component includes an access routing mechanism.

9. A memory control system of claim 1 wherein control component directs compensation of different clock rates of said plurality of heterogeneous components.

10. A memory control method comprising:
allocating internal memory to a plurality of heterogeneous components dynamically;
receiving access requests from said plurality of heterogeneous components; and
processing said access requests from said heterogeneous components to in accordance with said allocating.

11. A memory control method of claim 10 wherein said allocating includes allocating internal memory to said plurality of heterogeneous components

12. A memory control method of claim 10 wherein said allocating is performed dynamically in accordance with a performance indication.

13. A memory control method of claim 12 wherein said performance indication is a usage-case indication.

14. A memory control method of claim 12 wherein said performance indication is a bench mark indication.

15. A memory control method of claim 12 wherein said performance indication is an application indication.

16. A memory control method of claim 10 further comprising restricting ownership of the internal memory in accordance with allocation of said internal memory and access contention is prevented.

17. A processing system comprising:
a plurality of heterogeneous engines;
memory for storing information, including internal memory; and
a memory control system for controlling dynamic allocation of said memory to said plurality of heterogeneous engines, including dynamic allocation of said internal memory to said plurality of heterogeneous engines, and also controlling access to said memory.

18. A system of claim 17 wherein portions of said internal memory not allocated to said heterogeneous engines is allocated for dedicated usage by a particular component.

19. A system of claim 17 wherein a component of said internal memory is dedicated to either a processor cache usage or to on-chip memory buffer usage available to said heterogeneous engines.

20. A system of claim 17 wherein clock differences associated with said plurality of said heterogeneous engines is compensated for when accessing said memory.
